(19) United States
(12) Patent Application Publication
(10) Pub. No.: US 2023/0109369 A1
(43) Pub. Date: Apr. 6, 2023

(54) FIRST COPYRIGHT HOLDER AUTHENTICATION SYSTEM USING BLOCKCHAIN, AND METHOD THEREFOR

(71) Applicant: BRAINCOLLA INC., Seoul (KR)

(72) Inventor: Kang San KIM, Yongin-si (KR)

(73) Assignee: BRAINCOLLA INC., Seoul (KR)

(21) Appl. No.: 17/796,649

(22) PCT Filed: Jun. 26, 2020
(86) PCT No.: PCT/KR2020/008334

§ 371 Date: Jul. 30, 2022

(30) Foreign Application Priority Data
Feb. 27, 2020 (KR) 10-2020-0024062

(51) Int. Cl. G06F 21/10; H04L 9/40; H04L 9/32; H04L 9/00

(52) U.S. Cl. CPC G06F 21/10; H04L 63/083; H04L 9/3236; H04L 9/50

(57) ABSTRACT

The present invention relates to a system for authenticating an original copyright holder using a blockchain and a method of authenticating an original copyright holder using a blockchain. The system of the present invention includes a copyright holder terminal for inputting minimum unit information about an original work and generating a unique ID generation request signal of a copyright holder; a work management server that receives the unique ID generation request signal, generates unique ID information according to whether unique ID is authenticated, determines whether the minimum unit information is discriminatory or similar when receiving the minimum unit information, generates hash values including time information of the minimum unit information according to the determination results, and is connected to a blockchain network to store the generated hash values in a blockchain; and an authentication server for receiving information about the unique ID and the minimum unit information from the work management server and authenticating the received information.

### TECHNICAL FIELD

The present invention relates to a system for authenticating an original copyright holder using a blockchain and a method of authenticating an original copyright holder using a blockchain. More specifically, in the system of the present invention, when a minimum unit of work is completed, hash values of the work are generated based on completion time information about the work. The generated hash values are distributed and stored through a blockchain network, and an original copyright holder for the work is registered. Accordingly, the system may protect the work of the original copyright holder even when the work is stolen or exercise of a right to the stolen work occurs.

### BACKGROUND ART

In general, blockchain technology is not operated by a central system, but uses distributed computing resources. Accordingly, blockchain technology has the characteristics of decentralization. All transactions made through a blockchain may be managed fairly. In addition, when using a blockchain, transactions may be traced from the time the transactions occurred. Thus, legitimate transactions may be activated, and the cost of regulation may be reduced. Also, since a blockchain has a structure in which blocks are connected to each other like a chain, blockchain technology may prevent forgery and alteration and has the characteristics of scalability.

In recent years, blockchain technology has been widely applied and used in various industrial fields. In particular, blockchain technology is used to protect copyrights for content such as books, music, and videos.

For example, Korean Patent No. 10-1897032 discloses a system for distributing, storing, and managing the histories of creation, modification, and distribution of works in one or more copyright protection devices. The system has high security and prevents hacking in an entire distribution system. In addition, Korean Patent No. 10-1897032 discloses a method of protecting copyrights including a step of receiving, by a first terminal, a request to transmit a file for which copyright protection is requested to a second terminal; a step of generating and storing, by the first terminal, blockchain data corresponding to transmission to the second terminal; a step of transmitting, by the first terminal, transmission data including the file and the blockchain data to the second terminal; inquiring, by at least one of the first and second terminals, changes in chain information related to the blockchain data; and a step of receiving inquired change and changing the chain information of blockchain data by the terminal holding blockchain data corresponding to change among the first and second terminals.

However, according to the related art, blockchaining is not made at the time of initial registration of a work to be registered in the copyright protection device. Accordingly, when registering a similar work, it may be difficult to protect the work of an original copyright holder.

### RELATED ART DOCUMENTS

(Patent Document 1) Korean Patent No. 10-1897032

### DISCLOSURE

### Technical Problem

Therefore, the present invention has been made in view of the above problems, and it is one object of the present invention to provide a system for authenticating an original copyright holder using a blockchain and a method of authenticating an original copyright holder using a blockchain. More specifically, in the system of the present invention, when a minimum unit of work is completed, hash values of the work are generated based on completion time information about the work. The generated hash values are distributed and stored through a blockchain network, and an original copyright holder for the work is registered. Accordingly, the system may protect the work of the original copyright holder even when the work is stolen or exercise of a right to the stolen work occurs.

It is another object of the present invention to provide a system for authenticating an original copyright holder using a blockchain and a method of authenticating an original copyright holder using a blockchain. More specifically, in the system of the present invention, by facilitating identification of the source of an initially registered work that is distributed and stored through a blockchain network and achieving clear management and distribution, illegal copying and illegal distribution may be prevented in advance.

It is still another object of the present invention to provide a system for authenticating an original copyright holder using a blockchain and a method of authenticating an original copyright holder using a blockchain. More specifically, in the system of the present invention, even when copying of an originally registered work occurs, tracing may be performed through a blockchain network. In addition, by charging a copyright fee for the traced copy, in addition to the initially registered work, a copyright for the copied work may also be protected, thereby maximizing protection of the work.

According to the present invention, it is possible to accurately specify the time when each work was first written in connection with work and copyright registration in a copyright registration system.

However, the objects of the present invention are not limited to the above-described objects. In addition, even when not explicitly mentioned, the objects or the effects which can be grasped from the technical solution or the embodiments are also included in the objects of the present invention.

### Technical Solution

In accordance with one aspect of the present invention, provided is a system for authenticating an original copyright holder using a blockchain including a copyright holder terminal for inputting minimum unit information about an original work and generating a unique ID generation request signal of a copyright holder; a work management server that receives the unique ID generation request signal, generates unique ID information according to whether unique ID is authenticated, determines whether the minimum unit information is discriminatory or similar when receiving the minimum unit information, generates hash values including time information of the minimum unit information according to the determination results, and is connected to a blockchain network to store the generated hash values in a blockchain; and an authentication server for receiving information about the unique ID and the minimum unit information from the work management server and authenticating the received information.

According to one embodiment of the present invention, the work management server may include an ID generator that is connected to the copyright holder terminal through a network and generates the unique ID information; a work input device that determines whether the minimum unit information transmitted from the copyright holder terminal is discriminatory, judges the minimum unit information as a work only when the minimum unit information is determined as information having discrimination, and generates time information of the minimum unit information; and a main blockchain generator that is interlocked with the work input device, generates hash values consisting of the minimum unit information having discrimination, time information, identification information for the minimum unit information, and unique ID information corresponding to the minimum unit information, and distributes and stores the generated hash values in a main blockchain.

According to one embodiment of the present invention, when an authentication failure message for unique ID information is transmitted from the authentication server, the ID generator may transmit the authentication failure message and a unique ID information re-request signal to the copyright holder terminal.

According to one embodiment of the present invention, the work input device may be configured to determine based on whether a minimum unit value for determining as a work is satisfied when determining whether the minimum unit information is discriminatory.

According to one embodiment of the present invention, the minimum unit value may consist of completed title information or completed sentence information corresponding to the minimum unit information, may consist of a predetermined number of words included in text data included in the minimum unit information, or may be a case in which a size of the minimum unit information is larger than a size of predetermined data.

According to one embodiment of the present invention, the system may further include a work registration server that receives unique ID information, minimum unit information, and episode information of a copyright holder to be registered as copyrights from the work management server and transmits the received information to an external copyright registration server for copyright registration.

According to one embodiment of the present invention, the work management server may further include a work DB that stores unique ID information and blockchain information and transmits the stored information upon request of the work registration server for copyright registration.

According to one embodiment of the present invention, the work management server may further include a sub-blockchain generator that receives episode information for minimum unit information included in the main blockchain from the copyright holder terminal or the work input device and generates a sub-blockchain for the received episode information.

According to one embodiment of the present invention, the work management server may further include a copy copyright management device for protecting a copyright for a copied work when an original work consisting of the minimum unit information and the episode information is copied.

According to one embodiment of the present invention, the unique ID information may include identification information including personal information and artist number information of a copyright holder, electronic wallet information, encryption key and public key information, and work number information for existing works of the copyright holder.

According to one embodiment of the present invention, the minimum unit information may consist of text data and may include one or more of title information of a work to be registered, text information of a work to be registered, information about more than a certain number of words, and signature information that is entered into a work of a copyright holder to indicate that the work is the work of the copyright holder.

In accordance with another aspect of the present invention, provided is a method of authenticating an original copyright holder using a blockchain, wherein the method is a method of authenticating an original copyright holder through a system for authenticating an original copyright holder using a blockchain and includes a unique ID generation step of generating unique ID information of a copyright holder corresponding to an owner of a work; a minimum unit information input step of receiving minimum unit information about an original work from a copyright holder terminal receiving the unique ID information from a work management server and determining whether the received minimum unit information is discriminatory; a minimum unit information authentication step of determining whether the minimum unit information has similarity in an authentication server and performing authentication according to the determination results when the minimum unit information has discrimination; and a main blockchain generation step of generating hash values for the minimum unit information authenticated in a work management server and unique ID information corresponding to the minimum unit information, generating a main blockchain including the generated hash values, and storing the hash values.

According to another embodiment of the present invention, the method may further include an episode information input step of inputting episode information about the minimum unit information to a work management server after the main blockchain generation step; an episode information authentication step of performing authentication for discrimination and similarity by transmitting the inputted episode information to an authentication server; and a sub-blockchain generation step of generating hash values for the authenticated episode information and storing the generated hash values in a sub-blockchain.

According to another embodiment of the present invention, the method may further include a copyright registration step of, after the sub-blockchain generation step, transmitting minimum unit information and episode information included in a main blockchain and a sub-blockchain to a copyright registration server to register copyrights for the information.

### Advantageous Effects

According to an embodiment of the present invention, by distributing and storing the hash values of a minimum unit of work through a blockchain network and registering an original copyright holder for the work, the work can be protected even when the work of the original copyright holder is stolen or exercise of a right to the stolen work occurs, thereby by maximizing protection of the rights of the initially registered work and the registered copyright holder of the work.

In addition, according to an embodiment of the present invention, by facilitating identification of the source of an initially registered work that is distributed and stored through a blockchain network and achieving clear management and distribution, occurrence of illegal copying and illegal distribution can be minimized

In addition, according to an embodiment of the present invention, even when copying of an originally registered work occurs, by charging a copyright fee for the traced copy, in addition to the initially registered work, a copyright for the copied work can also be protected.

In addition, according to an embodiment of the present invention, it is possible to accurately specify the time when each work was first written in connection with work and copyright registration in a copyright registration system.

The present invention is not limited to the above description, and various beneficial advantages and effects of the present invention can be easily understood through the description of specific embodiments.

### DESCRIPTION OF DRAWINGS

FIG. 1 is a block diagram schematically showing a system for authenticating an original copyright holder using a blockchain according to an embodiment of the present invention.

FIG. 2 is a block diagram schematically showing a work management server included in a system for authenticating an original copyright holder using a blockchain according to an embodiment of the present invention.

FIG. 3 is a block diagram schematically showing a work registration server included in a system for authenticating an original copyright holder using a blockchain according to an embodiment of the present invention.

FIG. 4 is an exemplary diagram showing detailed information of a blockchain generated by a system for authenticating an original copyright holder using a blockchain according to an embodiment of the present invention.

FIG. 5 is a flowchart for explaining a method of authenticating an original copyright using a system for authenticating an original copyright holder using a blockchain according to an embodiment of the present invention.

FIG. 6 is a flowchart for explaining a method of registering an original copyright using a system for authenticating an original copyright holder using a blockchain according to an embodiment of the present invention.

FIG. 7 is a flowchart for explaining a process of authenticating and registering an original copyright through a system for authenticating an original copyright holder using a blockchain according to an embodiment of the present invention.

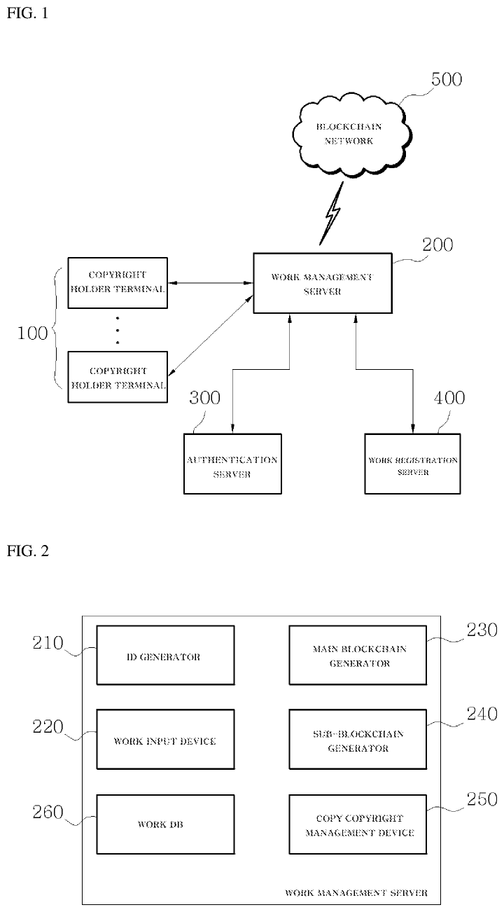

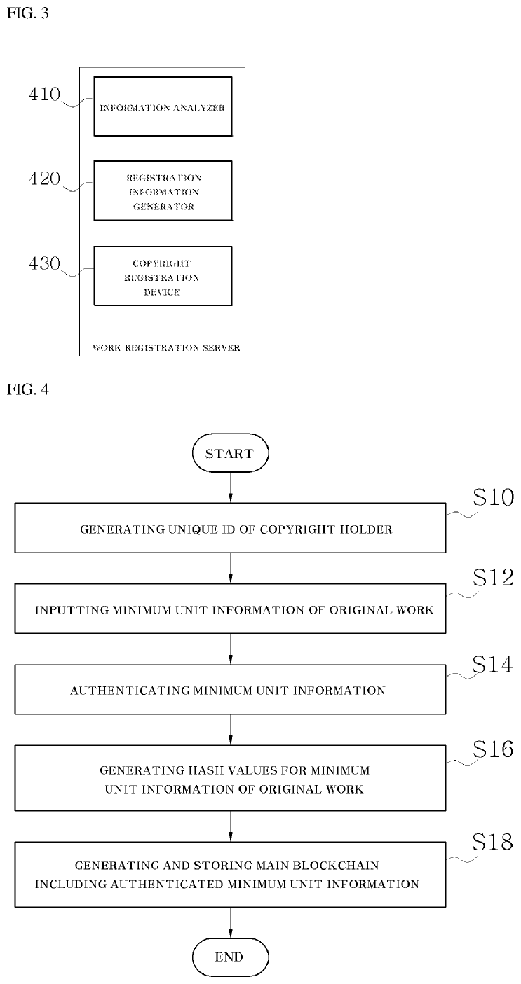

### BEST MODE FOR CARRYING OUT THE INVENTION

Hereinafter, preferred embodiments of the present invention will be described in detail with reference to the accompanying drawings. First, when reference numerals are applied to constituents illustrated in each drawing, it should be noted that like reference numerals indicate like elements throughout the specification. In addition, in the following description of the present invention, a detailed description of known functions and configurations incorporated herein will be omitted when it may make the subject matter of the present invention unclear.

In addition, in the present invention, some of operations or functions described as being performed by a terminal, an apparatus, or a device may be performed in a server connected to the terminal, the apparatus, or the device. In addition, some of operations or functions described as being performed by a server may be performed in a terminal, an apparatus, or a device connected to the server.

In addition, each server, terminal, and device EH described in each embodiment of the present invention may be a computer device or a system implemented with a plurality of computer devices that provides commands, codes, files, contents, services, and the like by communicating with a device through a network, and may include a memory, a processor, a communication interface, an input/output interface, and a database.

In particular, a means for executing a system according to each embodiment of the present invention may include an application connected through a network or a web server. A terminal, which is a means for reading recording medium in which the application or the web server is recorded, may include a general PC such as a desktop and a notebook computer and a mobile terminal such as a smart phone and a tablet PC.

In addition, A network described in the present invention means a connection structure capable of exchanging information between each node, such as a plurality of terminals and servers. For example, the network may include RF, 3rd generation partnership project (3GPP) network, long term evolution (LTE) network, 5rd generation partnership project (5GPP) network, world interoperability for microwave access (WIMAX) network, Internet, local area network (LAN), wireless local area network (wireless LAN), wide area network (WAN), personal area network (PAN), Bluetooth network, NFC network, a satellite broadcast network, an analog broadcast network, and digital multimedia broadcasting (DMB) network, without being limited thereto.

In addition, works described in the present invention are not limited to ordinary books, magazines, pamphlets, and the like, but include written works, oral works such as speeches, and works composed of texts such as record jackets. In the case of a catalog or contract, when expression thereof is original, the catalog or contract may be included as a work.

### DESCRIPTION OF SYMBOLS

100: COPYRIGHT HOLDER TERMINAL 200: WORK MANAGEMENT SERVER

210: ID GENERATOR 220: WORK INPUT DEVICE

230: MAIN BLOCKCHAIN GENERATOR 240: SUB-BLOCKCHAIN GENERATOR

250: COPY COPYRIGHT MANAGEMENT DEVICE 260: WORK DB

300: AUTHENTICATION SERVER 400: WORK REGISTRATION SERVER

410; INFORMATION ANALYZER 420: REGISTRATION INFORMATION GENERATOR

430: COPYRIGHT REGISTRATION DEVICE 500: BLOCKCHAIN NETWORK

### MODE FOR CARRYING OUT THE INVENTION

Hereinafter, embodiments of the present invention will be described in detail with reference to the accompanying drawings.

As shown in the drawings, a system for authenticating an original copyright holder using a blockchain according to the present invention is configured such that minimum unit information about an original work is input, and includes a copyright holder terminal 100 for requesting creation of unique ID of a copyright holder; a work management server 200 that is connected to the copyright holder terminal 100 through a network, generates the unique ID and provides the unique ID to the copyright holder terminal 100, generates hash values corresponding to minimum unit information of an original work, and is connected to a blockchain network to store the generated hash values in a blockchain; an authentication server 300 for determining similarity between the minimum unit information of the original work and episode information about the original work and performing authentication for a dissimilar work; a copyright registration server 400 for performing copyright registration procedure for the minimum unit information and the episode information of the authenticated original work; and a blockchain network 500 that is connected to the work management server 200 through a network and generates a blockchain for the minimum unit information and the episode information of the original work based on the unique ID and the hash values of the copyright holder terminal 100 transmitted from the work management server 200.

The copyright holder terminal 100 generates a unique ID of a copyright holder corresponding to an owner of an original work to connect the original work to a blockchain and provides an authoring tool so that text information for the original work to be connected with the blockchain is input. Although described in detail later, the unique ID of the copyright holder may be provided by the work management server. In addition, the authoring tool is output from a copyright holder terminal, and data input through the authoring tool may be stored in the work management server in real time. For example, the authoring tool may be operating in the work management server in a cloud manner.

The copyright holder terminal 100 is connected to the work management server 200 through a network to transmit and receive data through communication. The copyright holder terminal 100 transmits minimum unit information of an original work to the work management server 200 so that information included in the unique ID of a copyright holder and information about the generation time of the original work are stored in a blockchain.

In this case, the unique ID may include identification information including personal information and author number information of a copyright holder, electronic wallet information, and encryption key and public key information and may further include work number information about the existing works of a copyright holder. In this case, work number information of existing works may be information about a work registered through a work registration server 400.

In addition, the minimum unit information of an original work may consist of text data and corresponds to the minimum information of a work to be connected to a blockchain. Preferably, the minimum unit information consists of title information of a work to be registered, sentence information about the first sentence of the first episode among episode information of a work to be registered, or signature information that is entered into the work of a copyright holder to indicate that the work is the work of the copyright holder, without being limited thereto. When input information is determined as a work, the minimum unit information may consist of information about more than a certain number of words. Here, when a request for generating a unique ID is made, the copyright holder terminal 100 is configured to activate a unique ID input interface through which information corresponding to the unique ID is input to input the unique ID information. When input of the unique ID information is completed, the copyright holder terminal 100 transmits the unique ID information to an ID generation unit 210 of the work management server 200 to generate the unique ID of a copyright holder.

In addition, the copyright holder terminal 100 controls activation of an authoring tool so that minimum unit information of an original work is input and transmits the minimum unit information input by the authoring tool to a work input unit 220 of the work management server 200 to determine whether the input minimum unit information is discriminatory.

In addition, the copyright holder terminal 100 of the present invention receives discrimination determination result information for minimum unit information from the work input device 220 and outputs the discrimination determination result information.

In addition, when the discrimination determination result information is output, when the discrimination determination result information is analyzed, the minimum unit information does not satisfy a minimum unit value set by the work input unit 220, and re-input of the minimum unit information of an original work is required, the copyright holder terminal 100 also outputs information about the minimum unit value.

Accordingly, a copyright holder checks the reference value (minimum unit value) of the minimum unit information and then executes re-input, thereby preventing repeated errors in input of the minimum unit information.

In addition, the copyright holder terminal 100 of the present invention receives authentication result information about whether minimum unit information and episode information are similar from the work input device 220 and outputs the transmitted authentication result information to check whether the minimum unit information of an original work is similar to another work.

The work management server 200 is connected to the copyright holder terminal 100 through a network, generates unique ID corresponding to a unique ID generation request signal transmitted from the copyright holder terminal 100 and transmits the unique ID to the copyright holder terminal 100, determines whether minimum unit information about an original work is discriminatory and generates hash values including input time information about the minimum unit information, generates a blockchain for the minimum unit information through a blockchain network, and distributes and stores the blockchain. When episode information about an original work is transmitted from the copyright holder terminal 100, the work management server 200 generates a blockchain including episode information and distributes and stores the blockchain while registering copyrights for the minimum unit information and the episode information.

The work management server 200 is connected to the authentication server 300 through a network and includes the ID generator 210 for generating unique ID information corresponding to a unique ID generation request signal, the work input device 220 for determining whether minimum unit information about an original work transmitted from the copyright holder terminal 100 is discriminatory, and a main blockchain generator 230 that is interlocked with the work input device 220 and generates a blockchain for the minimum unit information.

The ID generator 210 receives a unique ID generation request signal from the copyright holder terminal 100, generates unique ID information corresponding to the received unique ID generation request signal, and transmits the unique ID information to the copyright holder terminal 100 .

That is, the ID generator 210 generates the unique ID of a copyright holder corresponding to an original copyright holder so that authentication of the original copyright holder of a work input through the copyright holder terminal 100 is performed and generates unique ID information to be stored when the original work is stored in a blockchain.

When unique ID is generated, the ID generator 210 transmits personal information about a copyright holder (original copyright holder) among unique ID information included in a unique ID generation request signal transmitted from the copyright holder terminal 100 to the authentication server 300 to perform authentication of the copyright holder. According to the authentication results, the ID generator 210 generates unique ID.

When an authentication failure message for unique ID information is transmitted from the authentication server 300, the ID generator 210 transmits the authentication failure message and a unique ID information re-request signal to the copyright holder terminal 100. When an authentication success message for unique ID information is transmitted, the ID generator 210 generates unique ID corresponding to the unique ID information and transmits the unique ID to the copyright holder terminal 100 while storing generated unique ID information.

When minimum unit information of an original work is transmitted from the copyright holder terminal 100, the work input device 220 determines whether the minimum unit information is discriminatory. When the minimum unit information is determined as information having discrimination, the work input device 220 judges the minimum unit information as a work, generates time information of the minimum unit information, and transmits the time information to the main blockchain generator 230.

In this case, the work input device 220 is preferably configured to transmit minimum unit information having discrimination to a work DB 260 for storage. As discrimination determination results of the minimum unit information, when a minimum unit value for determining as a work is not satisfied, the work input device 220 transmits information about the minimum unit value of the minimum unit information to the copyright holder terminal 100 and re-requests minimum unit information satisfying the minimum unit value.

In this case, the minimum unit value of minimum unit information consists of completed title information or completed sentence information corresponding to the minimum unit information, consists of a predetermined number of words included in text data included in the minimum unit information, or is a case in which a size of the minimum unit information is larger than a size of predetermined data. Whether signature information of a copyright holder is included or whether a period is formed in a completed title or sentence may be used as a criterion.

For example, when minimum unit information transmitted from the copyright holder terminal 100 consists of title information about a work, when the title information has been input, the work input device 220 determines whether a period has been formed. Only when both of the above conditions are satisfied, the work input device 220 may determine that the minimum unit information is a work having discrimination.

In addition, as another example, when the number of words in text data included in the minimum unit information is greater than or equal to a predetermined number (e.g., 10 to 15 words), the work input device 220 determines that the minimum unit information is a work having discrimination, generates input time information corresponding to time information of the minimum unit information, and transmits the minimum unit information and the input time information to the main blockchain generator 230.

As another example, whether minimum unit information is discriminatory, i.e., whether minimum unit information corresponds to a work or the minimum unit information of an original work may be collectively determined by whether input data includes the minimum number of characters, words, or sentences. For example, to satisfy the requirements of a work, when more than five sentences of text are input to a copyright holder terminal or a work management server, the copyright holder terminal or the work management server may determine the text as a work. The input time is regarded as the first completion time of the work.

In addition, as a result of determining discrimination of minimum unit information, when a minimum unit value is satisfied, the work input device 220 of the present invention transmits the minimum unit information to the authentication server 300 to determine whether the minimum unit information is similar.

The main blockchain generator 230 is connected to the blockchain network 500 and generates, through the blockchain network 500, a main blockchain including minimum unit information about an original work transmitted from the work input device 220 and time information and unique ID information of the minimum unit information.

The main blockchain generator 230 generates hash values consisting of minimum unit information, time information, identification information for the minimum unit information, and unique ID information corresponding to the minimum unit information, performs blocking of the generated hash values, and transmits the hash values to the blockchain network 500 to generate a main blockchain. At this time, a node where the main blockchain is stored is set as a main node.

Here, the blockchain network 500 connects blocks for data consisting of minimum unit information, time information, and unique ID information corresponding to the minimum unit information with a chain and records these information in a distributed ledger. The blockchain network 500 is a consensus system made up of a plurality of devices, is configured such that information corresponding to hash values is distributed and stored in some storage spaces of each node, and may consist of a plurality of chains. Each blockchain may be either a private blockchain or a public blockchain.

In addition, when generation and storage of the main blockchain are completed, the main blockchain generator 230 of the present invention transmits a blockchain generation completion signal to the copyright holder terminal 100 so that creation time of an original work is confirmed.

In addition, when a participant of the blockchain network 500 has a request to view or inquire about a generated main blockchain, the main blockchain generator 230 receives a main blockchain view request signal through the blockchain network 500 and transmits the received request signal to the copyright holder terminal 100 so that reading or inquiry of the corresponding main blockchain is approved.

The work management server 200 of the present invention may further include the work DB 260 that stores unique ID information of the copyright holder terminal 100, work information corresponding to the unique ID information, and blockchain information in which the work is distributed and stored and is connected to the work registration server 400 through a network to provide stored data and register a work.

In addition, the work management server 200 of the present invention may further include a sub-blockchain generator 240 for receiving episode information about an original work included in a main blockchain from the copyright holder terminal 100 or the work input device 220 and generating a sub-blockchain for the received episode information.

The sub-blockchain generator 240 is connected to the blockchain network 500, receives the hash values of a main blockchain corresponding to the upper level information of episode information from the main blockchain generator 230 when the episode information is received, performs blocking of data including the hash values of the main blockchain and the episode information, and connects the blocks with a chain to store the blocks in a distributed ledger through the blockchain network 500.

In this case, the sub-blockchain generator 240 is configured to perform distributed storage in a sub-node where distributed storage of a sub-blockchain is to be performed through the blockchain network 500.

Here, the episode information includes an episode number according to an original work composed of minimum unit information, identification information and title information of the original work, and episode content information.

In addition, the sub-blockchain generator 240 may be configured to receive episode information through the work input unit 220 when receiving episode information, and the received episode information may be configured to receive only information that has been authenticated from the authentication server 300 through the work input device 220 to generate and store a sub-blockchain.

In addition, in the work management server 200 of the present invention, distributed storage is performed by a blockchain. When a work registered through the work registration server 400 is copied, the work management server 200 may further include a copy copyright management device 250 that charges a copyright fee for the copied work, so that not only an initially registered work, but also a copyright for the copied work is protected. In addition, the work registration server may be a server operated by the Copyright Commission or may be an intermediate server for work registration communicating with a server operated by the Copyright Commission.

The copy copyright management device 250 receives hash values included in each blockchain from the work DB 260 when generating and storing a main blockchain and a sub-blockchain, checks whether information included in each of the provided hash values is copied through a web server or an app (APP), and transmits billing information according to use of the copied work to the corresponding web server or app when a copy is made.

According to an embodiment of the present invention, to check whether a registered work is copied, the copy copyright management device 250 compares the text data of minimum unit information and episode information included in the hash values of a blockchain for the corresponding work with text data output through a web server or an app where a copy is made and determines whether the two text data match. When the two text data match, the copy copyright management device 250 determines that the registered work is copied.

The authentication server 300 authenticates the personal information of a copyright holder included in unique ID information to generate the unique ID of the copyright holder terminal 100, is connected to the work input device 220 of the work management server 200 through a network, receives minimum unit information and episode information transmitted from the copyright holder terminal 100 through the work input device 220, and determines whether the transmitted minimum unit information and episode information are similar to a work already registered.

In this case, the similarity determination is to determine to what extent the minimum unit information is similar to the already registered copyright. Preferably, similarity is determined by comparing the form of minimum unit information and the form of an already registered copyright.

That is, when the form of minimum unit information transmitted from the work input device 220 is title information, the title information may be compared with the title information of an already registered copyright, and it may be determined whether the title information matches. Then, according to the comparison results, authentication result information may be generated and transmitted to the work input device 220.

Here, when the minimum unit information or the episode information consists of predetermined words, it is determined whether these predetermined words and words included in a copyright already registered consecutively match. When the words match consecutively, it is determined that the minimum unit information or the episode information is similar to the already registered copyright, and thus authentication result information is transmitted to the work input device 220.

The copyright registration server 400 registers the copyright of an original work distributed and stored through the blockchain network 500, receives unique ID information, minimum unit information, and episode information of a copyright holder to be registered as copyrights from the work DB 260 of the work management server 200, transmits the received information to an external copyright registration server to generate and transmit a copyright registration request signal for copyright registration.

The copyright registration server 400 includes an information analyzer 410 for analyzing minimum unit information and episode information and generating summary information about a work to be registered as a copyright, a registration information generator 420 for generating registration information including external disclosure method and external disclosure time of the summary information generated by the information analyzer 410, and a copyright registration device 430 for transmitting registration information generated in the registration information generator 420 to an external copyright registration server to perform copyright registration of the minimum unit information and episode information.

The information analyzer 410 summarizes minimum unit information and episode information made of predetermined text data and generates summary information about a work to be registered as a copyright.

In addition, the registration information generator 420 generates registration information including publication time information about the publication date and time of the summary information and media information to be published and transmits the generated registration information and summary information to the copyright registration device 430 for copyright registration.

Hereinafter, a method of authenticating an original copyright holder using the system for authenticating an original copyright holder will be described.

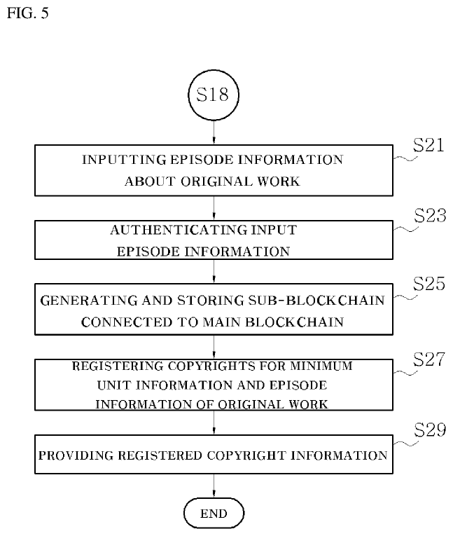

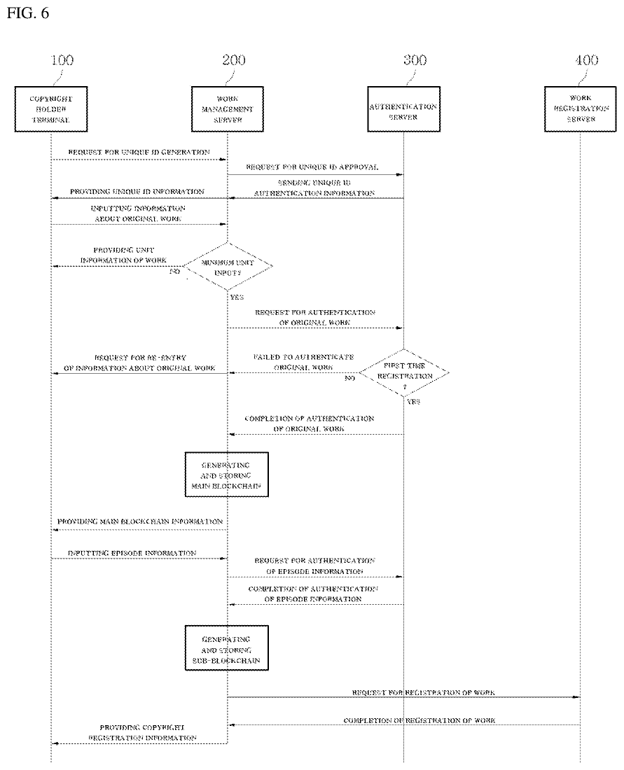

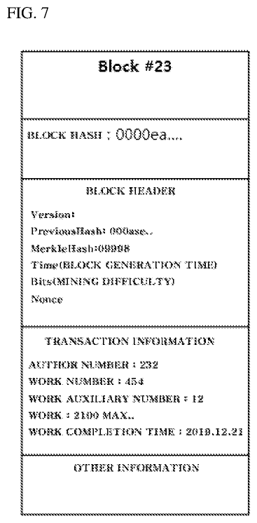

As shown in FIGS. 4 to 6, the method of authenticating an original copyright holder is a method of authenticating the ownership of a work by storing time information of an original work as a blockchain. According to the method of the present invention, to connect an original work to a blockchain, a unique ID generation step S10 of generating unique ID information of a copyright holder corresponding to an owner of a work is performed.

In unique ID generation step S10, the copyright holder terminal 100 transmits a request signal requesting generation of unique ID information including identification information of a copyright holder having the ownership of an original work to the ID generator 210 of the work management server 200. The ID generator 210 that has received the unique ID information generation request signal is connected to the authentication server 300 through a network to authenticate the unique ID information. According to the authentication results, unique ID information is generated and transmitted to the copyright holder terminal 100.

Thereafter, minimum unit information input step S12 is performed. In step S12, the copyright holder terminal 100 that has received the authenticated unique ID information drives an authoring tool to input minimum unit information about an original work, and the input minimum unit information is transmitted to the work input device 220 of the work management server 200.

In minimum unit information input step S12, when minimum unit information is transmitted from the copyright holder terminal 100, the minimum unit information is received, and it is determined whether the received minimum unit information is discriminatory. As determination results, the minimum unit information is transmitted to the authentication server 300 only when the minimum unit information has discrimination as a work.

Then, minimum unit information authentication step S14 is performed. In step S14, the authentication server 300 determines whether the minimum unit information having discrimination is similar. As determination results, authentication is performed.

In addition, in minimum unit information authentication step S14, the work input device 220 receives similarity determination result information from the authentication server 300, the received similarity determination result information is transmitted to the copyright holder terminal 100, and the similarity determination result information is analyzed. When the minimum unit information is not similar to an already registered copyright, the minimum unit information and unique ID information corresponding to the minimum unit information are transmitted to the main blockchain generator 230.

At this time, when the minimum unit information does not satisfy the condition of minimum unit value, it is determined that the minimum unit information does not have discrimination. Thus, discrimination determination result information is transmitted to the copyright holder terminal 100 for re-input of minimum unit information.

Next, main blockchain generation step S16 of generating, by the main blockchain generator 230, hash values for minimum unit information and unique ID information and generating a main blockchain including the generated hash values is performed.

In main blockchain generation step S16, hash values consisting of minimum unit information, time information, identification information for the minimum unit information, and unique ID information corresponding to the minimum unit information are generated, blocking of the generated hash values is performed, and the hash values are transmitted to the blockchain network 500 to generate a main blockchain.

At this time, main blockchain generation step S16 may further include a step of transmitting a blockchain generation completion signal to the copyright holder terminal 100 when generation and storage of the main blockchain is completed and confirming time of creation of an original work.

In addition, the method of authenticating an original copyright holder of the present invention further includes episode information input step S210 of receiving, from the copyright holder terminal 100 or the work input device 220, episode information for minimum unit information of an original work included in the main blockchain generated in the above-described steps S10 to S16 and inputting the received episode information in the work input device 220.

Then, episode information authentication step S23 of transmitting the inputted episode information to the authentication server 300 and performing authentication for discrimination and similarity is performed.

In addition, sub-blockchain generation and storage step S25 of transmitting episode information authenticated by the authentication server to the sub-blockchain generator 240 to generate a sub-blockchain and storing information about the generated sub-blockchain is performed.

In sub-blockchain generation step S25, when receiving episode information, the hash values of a main blockchain corresponding to the upper level information of episode information are received from the main blockchain generator 230, blocking of data consisting of the hash values of the main blockchain and the episode information is performed, and the data is connected with a chain to store the data in a distributed ledger through the blockchain network 500.

Next, when generation of a sub-blockchain is completed, copyright registration step S27 of transmitting, from the work DB 260, minimum unit information and episode information included in the main blockchain and the sub-blockchain described above to the copyright registration server 400 to register copyrights for the information is performed.

In copyright registration step S27, a step of receiving minimum unit information and episode information from the work DB 260, analyzing the received minimum unit information and episode information, and generating summary information for a work to be registered as a copyright, a registration information generation step of generating registration information including external disclosure method and external disclosure time of the generated summary information, and a copyright registration step of transmitting the generated registration information to an external copyright registration server and performing copyright registration of the minimum unit information and the episode information are performed sequentially.

Then, when copyright registration is completed, copyright information providing step S29 of transmitting the registered copyright information to the copyright holder terminal 100 is performed.

The above description is only an example for explaining the technical idea of the present invention, and various modifications and variations will be made by those skilled in the art to which the present invention pertains without departing from the essential characteristics of the present invention. Accordingly, the embodiments disclosed in the present invention are not intended to limit the technical spirit of the present invention, but to illustrate the present invention, and the scope of the technical spirit of the present invention is not limited by these embodiments. The protection scope of the present invention should be interpreted by the following claims, and all technical ideas within the equivalent range should be construed as being included in the scope of the present invention.

### INDUSTRIAL APPLICABILITY

The system of the present invention can be applied to industrial fields for registering and protecting copyrights. In particular, the system of the present invention can be applied to industrial fields for protecting data in digital form.

1. A system for authenticating an original copyright holder using a blockchain, comprising:
a copyright holder terminal for inputting minimum unit information about an original work and generating a unique ID generation request signal of a copyright holder;
a work management server that:
receives the unique ID generation request signal,
generates unique ID information according to whether unique ID is authenticated,
determines whether the minimum unit information is discriminatory or similar when receiving the minimum unit information,
generates hash values comprising time information of the minimum unit information according to the determination results, and
is connected to a blockchain network to store the generated hash values in a blockchain; and
an authentication server for receiving information about the unique ID and the minimum unit information from the work management server and authenticating the received information.

2. The system according to claim 1, wherein the work management server comprises:
an ID generator that is connected to the copyright holder terminal through a network and generates the unique ID information;
a work input device that determines whether the minimum unit information transmitted from the copyright holder terminal is discriminatory, judges the minimum unit information as a work only when the minimum unit information is determined as information having discrimination, and generates time information of the minimum unit information; and
a main blockchain generator that is interlocked with the work input device, generates hash values consisting of the minimum unit information having discrimination, time information, identification information for the minimum unit information, and unique ID information corresponding to the minimum unit information, and distributes and stores the generated hash values in a main blockchain.

3. The system according to claim 2, wherein, when an authentication failure message for unique ID information is transmitted from the authentication server, the ID generator transmits the authentication failure message and a unique ID information re-request signal to the copyright holder terminal.

4. The system according to claim 2, wherein:
the work input device is configured to determine based on whether a minimum unit value for determining as a work is satisfied when determining whether the minimum unit information is discriminatory, and
the minimum unit value consists of completed title information or completed sentence information corresponding to the minimum unit information, consists of a predetermined number of words comprised in text data comprised in the minimum unit information, or is a case in which a size of the minimum unit information is larger than a size of predetermined data.

5. The system according to claim 1, further comprising a work registration server that receives unique ID information, minimum unit information, and episode information of a copyright holder to be registered as copyrights from the work management server and transmits the received information to an external copyright registration server for copyright registration.

6. The system according to claim 5, wherein the work management server further comprises a work DB that stores unique ID information and blockchain information and transmits the stored information upon request of the work registration server for copyright registration.

7. The system according to claim 2, wherein the work management server further comprises a sub-blockchain generator that receives episode information for minimum unit information comprised in the main blockchain from the copyright holder terminal or the work input device and generates a sub-blockchain for the received episode information.

8. The system according to claim 2, wherein the work management server further comprises a copy copyright management device for protecting a copyright for a copied work when an original work consisting of the minimum unit information and the episode information is copied.

9. The system according to claim 1, wherein the unique ID information comprises identification information including:
personal information and artist number information of a copyright holder,
electronic wallet information,
encryption key and public key information, and
work number information for existing works of the copyright holder.

10. The system according to claim 1, wherein the minimum unit information consists of text data and comprises one or more of:
title information of a work to be registered,
text information of a work to be registered,
information about more than a certain number of words, and
signature information that is entered into a work of a copyright holder to indicate that the work is the work of the copyright holder.

11. A method of authenticating an original copyright holder using a blockchain, wherein the method is a method of authenticating an original copyright holder through a system for authenticating an original copyright holder using a blockchain and comprises:
a unique ID generation step of generating unique ID information of a copyright holder corresponding to an owner of a work;
a minimum unit information input step of receiving minimum unit information about an original work from a copyright holder terminal receiving the unique ID information from a work management server and determining whether the received minimum unit information is discriminatory;
a minimum unit information authentication step of determining whether the minimum unit information has similarity in an authentication server and performing authentication according to the determination results when the minimum unit information has discrimination; and
a main blockchain generation step of generating hash values for the minimum unit information authenticated in a work management server and unique ID information corresponding to the minimum unit information, generating a main blockchain comprising the generated hash values, and storing the hash values.

12. The method according to claim 11, further comprising:
an episode information input step of inputting episode information about the minimum unit information to a work management server after the main blockchain generation step;
an episode information authentication step of performing authentication for discrimination and similarity by transmitting the inputted episode information to an authentication server; and
a sub-blockchain generation step of generating hash values for the authenticated episode information and storing the generated hash values in a sub-blockchain.

13. The method according to claim 12, further comprising a copyright registration step of, after the sub-blockchain generation step, transmitting minimum unit information and episode information comprised in a main blockchain and a sub-blockchain to a copyright registration server to register copyrights for the information.

14. A system for authenticating an original copyright holder using a blockchain, comprising a work management server that:
receives minimum unit information about an original work and a unique ID generation request signal of a copyright holder from an external terminal,
generates unique ID information according to whether unique ID is authenticated,
determines whether the minimum unit information is discriminatory when the minimum unit information is received,
generates hash values comprising information about the determination results and generation time information of the minimum unit information according to the determination results, and
is connected to a blockchain network to store generated hash values in a blockchain.

15. (canceled)
